(19) United States
(12) Patent Application Publication
(10) Pub. No.: US 2002/0162260 A1
(43) Pub. Date: Nov. 7, 2002

(54) Golf accessory with modular insert

(76) Inventor: John R. Tate, Garden Grove, CA (US)

Correspondence Address: Charles H. Thomas, CISLO & THOMAS LLP, Suite 405, 4201 Long Beach Blvd., Long Beach, CA, 90807-2022, US

(21) Appl. No.: 09/848,156

(22) Filed: May 4, 2001

(51) Int. Cl. G09F 3/04

(52) U.S. Cl. 40/630

(57) ABSTRACT

A golf accessory that is produced with slight variations in customized surface ornamentation on a recurring basis is fabricated by manufacturing it with two separate component elements. A main body portion is formed with a shallow tray having a flat floor recessed below the level of a surrounding rim. A modular insert bearing customized surface ornamentation is produced as a separate part. The modular insert is permanently secured in the tray defined in the main body to produce the finished golf accessory which has a customized surface ornamentation. By producing the main body as a separate part, a significant savings in tooling is achieved, since the molds or dies for the main body can be reused year after year. Smaller, simpler tooling for the modular insert must be produced on a recurring basis, but the cost of this tooling is substantially less than the cost of the new tooling that would be required to produce an entirely new main body part each time there is a change in surface ornamentation.

### SPECIFICATION

### BACKGROUND OF THE INVENTION

1. Field of the Invention

The present the invention relates to a unique construction for customized accessories utilized in the field of golf, such as divot repair tools, bill clips, golf bag tags, key rings, hat and lapel pins, zipper pulls, ball markers, and other accessories purchased and used by golfers.

2. Description of the Prior Art

In the game of golf certain golf accessories have endured as perennial favorites among golfers. For example, certain divot repair tools, bill clips, golf bag tags, key rings, hat and lapel pins, zipper pulls, ball markers, and other accessories purchased and used by golfers have been sold for years without any significant variations in the basic product configuration. However, these products are updated constantly with different surface ornamentations related to specific golf organizations and specific events. For example, different lines of the same basic products are often created for major golf tournaments, invitationals, and other golf related events wherein the products differ from those sold during previous years or at other clubs only in surface ornamentations.

Sometimes an entirely new logo or design is developed for a golfing event that is held annually so that the surface ornamentation of golf accessories created especially for that event differ markedly from those developed for the same event in prior years. For other golf events the same basic logo is retained year after year, but the calendar year of the event is changed on golf accessories created for sale to specifically commemorate that event.

Many golf accessories are formed utilizing molds or dies having intricate constructions which make them rather expensive. As a consequence, even though a particular golf accessory may change in configuration from year to year only in small areas of its surface configuration, an entirely new mold or die must be produced for each variation of the same basic product. Therefore, a considerable expense is incurred annually due to the cost of new die or mold construction. This large cost of new tooling with each variation of the same basic product adds considerably to the cost of manufacturing golf accessories for specific events. To sell these products economically, this large cost in tooling must be recovered by increasing the price of the product.

### SUMMARY OF THE INVENTION

A primary object of the present invention is to provide a system whereby large recurrent costs in tooling are avoided when a golf accessory is to be modified only by relatively small changes in its surface ornamentation. This objective is achieved by forming the accessory from component elements which are assembled together to produce the finished product. The first component is comprised of the basic body structure of the accessory which may include complex shapes that do not change year after year. For this reason, the same tooling can be used from one year to the next to produce the relatively complex portion of the basic structure. The second component is formed as a relatively simple shape, such as a slab or plate, upon which surface ornamentation is formed that changes from year to year.

While new tooling to create the second component must be created each time there is a change in surface ornamentation on the product, the cost of this new tooling is relatively small since the shape is quite simple. The two component elements of the product are permanently assembled together to produce a golf accessory that is virtually indistinguishable from an accessory that could be formed as a unitary structure. Nevertheless, the cost of manufacture is reduced considerably.

A related object of the invention is to allow golf accessories to be modified in surface ornamentation from year to year at a much lower cost than is presently possible using conventional manufacturing techniques and constructions. By manufacturing golf accessories with a major component that remains unchanged from one tournament to the next and a simple component that can be inexpensively produced for assembly with the major component, the cost of manufacturing golf accessories which are updated for each new golfing event is reduced.

In one broad aspect the present the invention may be considered to be an improvement in a golf accessory formed with a body and bearing customized surface ornamentation. According to the improvement of the invention the body defines a shallow tray with a floor recessed below the level of the surrounding rim. The accessory is also formed with a modular insert bearing the customized surface ornamentation and having an outer perimeter that conforms to and fits snugly within the confines of the rim. The insert is permanently secured in the tray.

In another broad aspect the invention may be considered to be a golf accessory formed with a body in which a flat, shallow tray is defined to form a floor with a surrounding rim, and a modular customized plate having an outer perimeter that fits snugly within the rim secured to the tray, preferably by adhesion to the floor of the tray.

In still another broad aspect the invention may be considered to be an improvement in a method of manufacturing a golf accessory formed with a body and bearing customized surface ornamentation. The improvement of the invention comprises: forming the body with a shallow tray with a floor recessed below the level of a surrounding rim, separately forming a modular insert bearing the customized surface ornamentation and having an outer perimeter that conforms to and fits snugly within the confines of the rim, and permanently securing the insert in the tray.

The invention may be described with greater clarity and particularity by reference to the accompanying drawings.

### DESCRIPTION OF THE DRAWINGS

FIG. 1 is a perspective view illustrating the two components of a golf accessory according to the invention manufactured separately according to the method of the invention.

FIG. 2 is a sectional elevational view of the components of the golf accessory of the invention shown in FIG. 1 prior to assembly together.

FIG. 3 is a sectional elevational view showing the components of the golf accessory of the invention of FIG. 2 after assembly.

FIG. 4 is a top plan view of the golf accessory of the invention shown in FIG. 1.

FIG. 5 is a bottom plan view of the golf accessory of the invention shown in FIG. 1.

FIG. 6 is a sectional elevational view showing an alternative embodiment of a golf accessory of the invention from that illustrated in FIG. 2.

### DESCRIPTION OF THE EMBODIMENTS AND IMPLEMENTATION OF THE METHOD

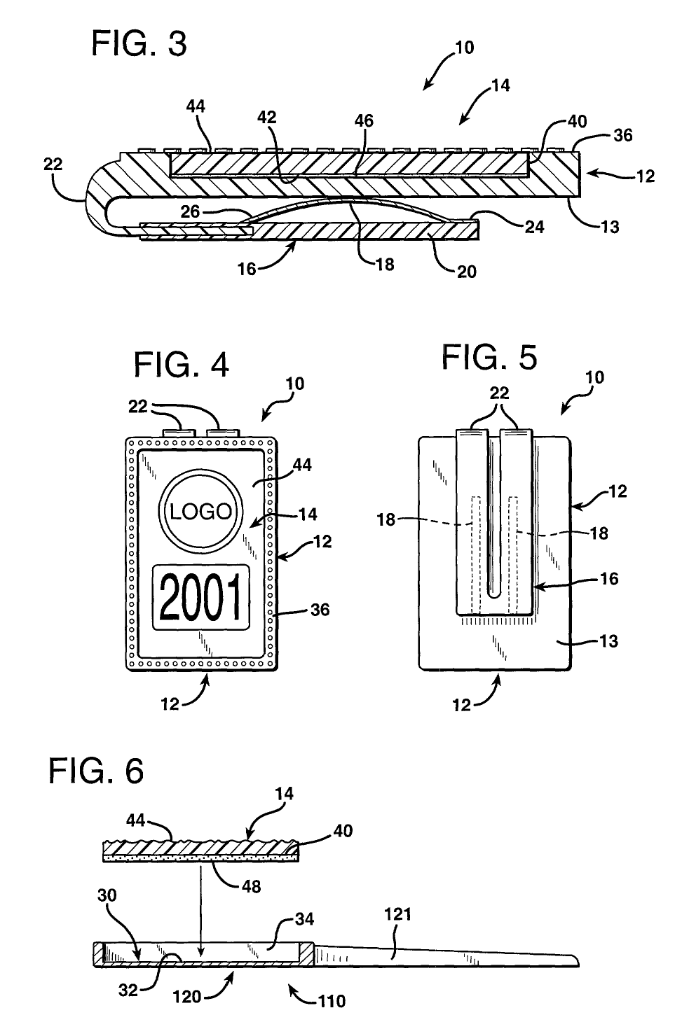

FIG. 1 illustrates a golf accessory 10 constructed according to the invention which, in the embodiment shown, is a bill clip. As shown in FIG. 3, the bill clip 10 is comprised of a body portion 12 and an insert 14. The body portion 12 has a clip member 16, and a pair of leaf springs 18. The clip member 16 is formed with a pair of elongated legs 20 which extend parallel to and in spaced separation from the backside of the body 12. At one of their ends the legs 20 terminate in a U-shaped return 22 that is formed as an extension from one end of the body 12 that resides beneath its backside 13. The opposite, free ends of the legs 20 are joined together and are secured to the ends 24 of a pair of bowed leaf springs 18. The convex centers of the leaf springs 18 are bowed toward the center of the backside 13 of the body 12. The opposite ends 26 of the bowed leaf springs 18 are unattached and are directed back toward the legs 20.

Articles, such as bills of currency, can be inserted in between the legs 20 and the backside 13 of the main body 12. With the insertion of bills of currency in between the bowed centers of the leaf springs 18 and the backside 13 of the main body 12, the leaf springs 18 are flexed and the free ends 26 thereof are pushed toward the U-shaped return 22 as the centers of the leaf springs 18 are flattened. The resiliency of the elastically deflected leaf springs 18 holds the bills of currency compressed between the bowed centers of the leaf springs 18 and the backside 13 of the main body 12.

The main body 12 is fabricated from dies or a mold and, in the embodiment illustrated, has a generally rectangular configuration with a flat backside 13. The opposite, obverse surface is formed with a low rectangular depression of uniform depth throughout that defines a flat, shallow tray 30 of a generally rectangular shape. The tray 30 has a flat, rectangular floor 32 surrounded by low, upright walls 34. The structure of the obverse surface of the main body 12 about the perimeter of the tray 30 forms a slightly raised peripheral rim 36 that surrounds the tray 30. The flat floor 32 is recessed beneath the level of the surrounding rim 36. The raised rim 36 may be stamped or molded with intricate surface ornamentation as illustrated in FIG. 1.

The insert 14 is a relatively simple structure. For example, it may be formed as a flat rectangular plate or slab which may be easily molded or stamped. The sides 40 and the bottom 42 of the flat slab forming the insert 14 are simple, flat structures. There may be a slight draft to the sides 40 of the insert 14 and to the walls 34 of the tray 30 to allow the insert 14 to be inserted into the tray 30 during assembly of the golf accessory 10. The exposed, outer exposed surface 44 of the flat insert 14 includes customized surface ornamentation which may include a logo of a particular golf tournament and the year in which that particular tournament is held.

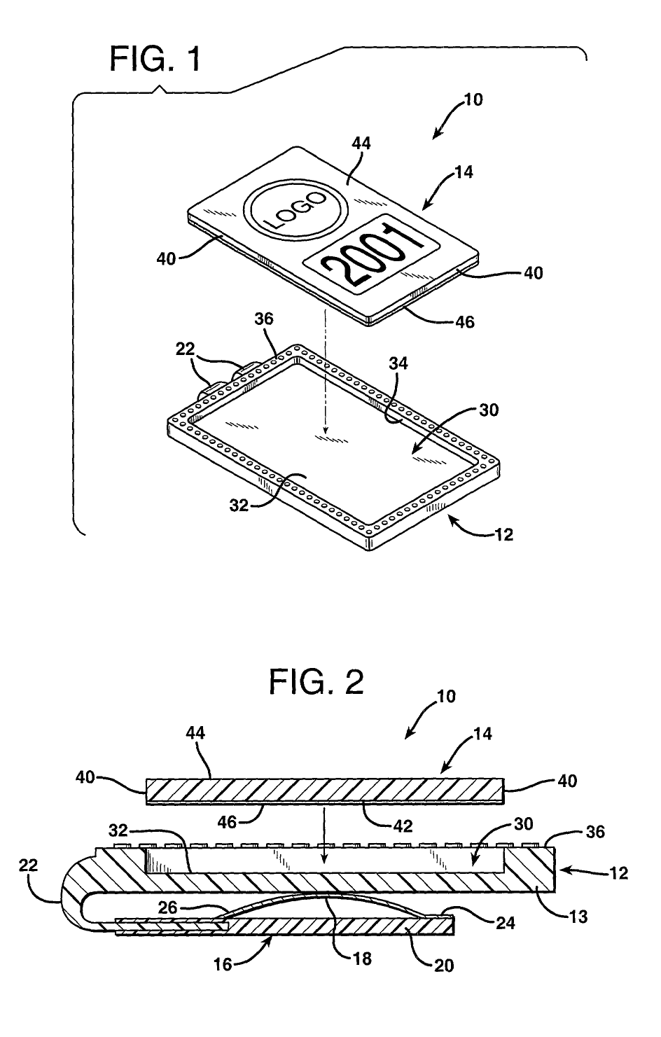

The walls 40 forming the outer perimeter of the modular insert 14 conform to and fit snugly within the confines of the rim 36 of the main body 12. The flat, concealed side 42 of the modular insert 14 opposite the exposed, decorated side 44 may be coated with a thin layer of adhesive 46 throughout its surface. When the modular insert 14 is pressed into the tray 30 from its initially separated position shown in FIG. 2 to fully assemble the golf accessory 10 as illustrated in FIG. 3, the flat, concealed underside 42 of the insert 14 is pressed into intimate contact and permanently sealed to the floor 32 of the tray 30. When the insert 14 is pressed into the tray 30 some of the adhesive 42 may be extruded up between the upright walls 34 of the tray 30 and the side walls 40 of the insert 14 so that the insert 14 is adhesively sealed to both the floor 32 and the walls 34 of the tray 30.

Once the golf accessory 10 is fully assembled, as illustrated in FIGS. 3 and 4, it is virtually impossible to tell that the major structure of the bill clip 10 has been formed from separate component elements. Nevertheless, the same dies or molds can be used year after year to produce the main body 12. A new set of dies or molds are produced each year or for each different event and are utilized to produce a different modular insert 14, having different custom surface ornamentation on the exposed side 44 with each different golf tournament or other golfing event. Because the modular inserts 14 are so simple in structure and are normally relatively small, the new dies required each year for an annual event and for golf events at different country clubs are relatively inexpensive, as compared to the cost of the dies necessary to produce the main body 12.

As a consequence, customized golf accessories 10 can be produced year after year and for different tournament events within the same year at a number of different country clubs using identical main bodies 12 for different customized golf accessories 10. The golf accessories 10 produced for each different event have a unique, customized appearance despite the fact that the main body portion 12 of each article of manufacture is identical.

Undoubtedly, numerous variations and modifications of the invention will become readily apparent to those familiar with the fabrication of golf accessories. For example, any number of different methods may be utilized to permanently secure the insert 14 in the shallow tray 30. FIG. 6 illustrates a different accessory from that illustrated and described in FIGS. 1-3, namely a golf divot repair tool 110. Also, strips 48 of double sided tape are substituted for the layer of adhesive 46 to permanently seal the concealed side 42 of the modular insert 14 to the floor 32 of the tray 30. In the embodiment of FIG. 6 both the top and bottom surfaces of these strips 48 of tape are coated with a pressure sensitive adhesive and the main body portion 120 is that of a golf divot repair tool having a pair of elongated, generally parallel legs 121, rather than a bill clip.

Other conventional means of permanently attaching the insert 14 to the main body may also be employed. For example, once the insert 14 has been pressed into the tray 30, the outer edges of the main body may be forced toward each other so that the rim 36 is slightly deformed in a lateral direction to allow the walls 34 of the tray 30 to tightly grip the sides 40 of the insert 14. Accordingly, the scope of the invention should not be construed as limited to the specific embodiments depicted and described, but rather is defined in the claims appended hereto.

I claim

1. In a golf accessory formed with a body and bearing customized surface ornamentation, the improvement wherein said body defines a shallow tray with a floor recessed below the level of a surrounding rim, and further comprising a modular insert bearing said customized surface ornamentation and having an outer perimeter that conforms to and fits snugly within the confines of said rim permanently secured in said tray.

2. A golf accessory according to claim 1 wherein said floor of said tray is flat and said insert is formed as a flat plate with said customized surface ornamentation on one exposed side and having an opposite, flat concealed side, and said flat concealed side of said insert is permanently secured to said floor of said tray.

3. A golf accessory according to claim 2 further comprising an adhesive that permanently seals said flat concealed side of said insert to said flat floor of said tray.

4. A golf accessory according to claim 2 further comprising double sided tape that permanently seals said flat, concealed side of said insert to said flat floor of said tray.

5. A golf accessory formed with a body in which a flat, shallow tray is defined to form a floor with a surrounding rim, and a modular, customized plate having an outer perimeter that fits snugly within said rim secured to said tray.

6. A golf accessory according to claim 5 wherein said modular, customized plate has a flat, concealed undersurface that is in contact throughout with said floor and an opposing decorative surface bearing customized surface ornamentation.

7. A golf accessory according to claim 6 further comprising adhesive that seals said concealed undersurface of said modular, customized plate to said floor of said tray.

8. A golf accessory according to claim 6 further comprising double sided tape that seals said concealed undersurface of said modular, customized plate to said floor of said tray.

9. A golf accessory according to claim 5 wherein said modular, customized plate bears an indicia of a particular golf tournament.

10. A golf accessory according to claim 5 wherein said modular customized plate bears an indicia of a particular golf organization.

11. A golf accessory according to claim 5 wherein said body forms a component of a bill clip.

12. A golf accessory according to claim 5 wherein said body forms a component of a golf divot repair tool.

13. In a method of manufacturing a golf accessory formed with a body and bearing customized surface ornamentation, the improvement comprising:
forming said body with a shallow tray having a floor recessed below the level of a surrounding rim,
separately forming a modular insert bearing said customized surface ornamentation and having an outer perimeter that conforms to and fits snugly within the confines of said rim, and
permanently securing said insert in said tray.

14. A method according to claim 13 further comprising permanently securing said insert by bonding said modular insert with an adhesive to said floor of said tray.

15. A method according to claim 13 further comprising permanently securing said insert by attaching it to said floor of said tray with double sided tape.

16. A method according to claim 13 further comprising forming said floor of said tray as a flat surface and forming said modular insert with a flat, concealed undersurface that resides in contact throughout with said floor of said tray.
